(19) United States
(12) Patent Application Publication
(10) Pub. No.: US 2008/0028334 A1
(43) Pub. Date: Jan. 31, 2008

(54) SEARCHABLE PERSONAL BROWSING HISTORY

(75) Inventor: Arjan De Mes, Leiden (NL)

Correspondence Address: IBM CORPORATION, IPLAW SHCB/40-3, 1701 NORTH STREET, ENDICOTT, NY, 13760, US

(73) Assignee: INTERNATIONAL BUSINESS MACHINES CORPORATION, Armonk, NY (US)

(21) Appl. No.: 11/836,320

(22) Filed: Aug. 9, 2007

Related U.S. Application Data
(63) Continuation of application No. 10/809,575, filed on Mar. 25, 2004.

(30) Foreign Application Priority Data
Jun. 25, 2003 (GB) 0314782.4

(51) Int. Cl. G06F 3/048

(52) U.S. Cl. 715/781

(57) ABSTRACT

A system, method and program product for creating a searchable personal browsing history. In response to a user request to obtain a web page from the Internet, metadata and textual data are automatically extracted from the web page. Then, the extracted metadata and textual data are indexed and stored. Subsequently, the stored metadata and textual data are displayed in categories based on the indexing, to enable searching of the displayed categories of metadata and textual data.

### FIELD OF THE INVENTION

The invention relates generally to computer systems and deals more particularly with a tool for tracking web browsing.

### BACKGROUND OF THE INVENTION

The World Wide Web (WWW) has evolved into a very useful tool for banking, shopping, booking hotels, rental cars and airline tickets, checking stock prices and searching for other types of information. The WWW comprises a vast multitude of individual webpages and files, and it is difficult to remember which web pages have been previously visited. Consider an example of searching the WWW using Google (Google is a registered trademark of Google Technology Inc) or Yahoo (Yahoo is a registered trademark of Yahoo! Inc.) search engine for a topic such as knowledge management. The search engine displays the results as a list of titles and hyperlinks to knowledge management websites. If the user selects a particular hyperlink from the search results a corresponding web page is displayed. Embedded within this web page may be other hyperlinks which direct a user to other knowledge management web pages which may or may not be of interest to the user. Once the user has found the web page with the information that he or she needs, the user can either print, download or bookmark the web page for future reference. However, a problem may occur later when the user tries to locate a web page which the user did not save, print or download this web page. In such a case, the users may resort to another search to attempt to find the same comparable web page.

It is known to cache web pages for later use. Most web browsers maintain in the client computer's local file system a cache of recently visited web pages and other web resources. Before displaying them in the web browser, an HTTP request is used to check with the original server that the cached web pages are the most current pages available. However, a web browser cache suffers the disadvantage that it is not well controlled and temporary in nature. It also requires periodic scanning/indexing in order for the information stored in the cache to be of any use to a user. Further, some web pages are never placed in the cache. Therefore the cache does not give a full indication of the web pages or web resources that a user has accessed over a particular period of time.

Another method of storing recently visited web pages is to save the web pages for off-line viewing. This facility is offered in current versions of Microsoft Internet Explorer. To save a visited web page for off line viewing, a user can bookmark the web page currently being accessed. Microsoft Internet Explorer provides a “wizard” which presents the user with a number of options to customize the content for off line viewing. A disadvantage with the foregoing approach is that a user has to actively select the web pages to be bookmarked.

Another approach can be found in a paper written by Manber U et al (to appear in 1997 Usenix Technical Conference, Jan. 6-10, 1997), (web reference http://webglimpse.org/pubs/webglimpse/pdf) from the Department of Computer Science, University of Arizona, Tucson. The paper discusses a tool called WebGlimpse which analyses collections of webpages. WebGlimpse analyses a given WWW archive for example a website, a collection of specific documents or a private history cache and computes neighborhoods i.e. the most relevant documents according to a user's specification. Once this has been completed, search boxes are added to selected pages, remote pages are collected if relevant and the pages are cached locally. Users are able to browse the website using any of the added search boxes. A disadvantage of this approach is that a user has to actively indicate to WebGlimpse that the user wishes to archive a particular website or a particular web page. Also, if a user later wants to locate a web page seen earlier, and the web page has not been archived, the user still must try to retrace his or her steps using their preferred search engine.

Yet another approach is discussed in a paper entitled ‘Lifestreams: organising your electronic life’ written by Freeman, E et al, from the department of Computer Science, Yale University, New Haven, United States. This paper describes a system which provides a time ordered stream of documents which functions as a diary of a persons electronic life. The paper describes creating a time ordered stream of documents starting with a person's electronic birth certificate. The time-ordered document stream moves toward the present day with more current documents that the user has added to the time-ordered document stream. A disadvantage of this approach is that a user must actively create a document which is subsequently added to the time-ordered document stream. Also, this approach is not suitable for saving web pages for off-line viewing because the user is required to actively indicate which web pages are to be saved.

An object of the present invention is to provide an improved method and system for storing web pages and other web resources accessed by a user.

Another object of the present invention is to provide a method and system of the foregoing type which also presents the accessed web resources to the user in a meaningful way.

### SUMMARY

The invention resides in a system, method and program product for creating a searchable personal browsing history. In response to a user request to obtain a web page from the Internet, metadata and textual data are automatically extracted from the web page. Then, the extracted metadata and textual data are indexed and stored. Subsequently, the stored metadata and textual data are displayed in categories based on the indexing, to enable searching of the displayed categories of metadata and textual data.

In accordance with a feature of the present invention, the user does not have to actively select that a data resource should be saved. Thus, the present invention provides an accurate account of the data resources accessed over a communications network by the user. The user may define the types of categories to be displayed in the searchable personal browsing history thereby personalising the data displayed. Further, a user may search the searchable personal browsing history and thereby create a view within the searchable personal browsing history defined by the search results and one or more user defined categories.

In accordance with another feature of the present invention, the extracted metadata and textual data are stored with a reference to the data resource's original location. This avoids need for a complete copy of the data resource to be stored in a data store.

In accordance with another feature of the present invention, a calculation is performed on the extracted metadata to create statistical information relating to a user's browsing activity. An advantage of this approach is that a user is able to view his or her browsing activity in categorised views which provides efficient access to the required information. Preferably the calculated statistical information provides a user with categories of recently visited web pages, most frequently visited web pages, recently visited downloads and/or recently visited images.

### BRIEF DESCRIPTION OF THE DRAWINGS

FIG. 1 illustrates a computer system in which is executed the personal browsing history application program according to the present invention.

FIG. 2 illustrates program components of the personal browsing history application program of FIG. 1.

FIG. 3 is a flowchart illustrating entry of historical web browsing data into the personal browsing history application program of FIG. 2.

FIG. 4 is a flowchart illustrating operation of the personal browsing history application program of FIG. 2 when generating a display of a personal browsing history.

FIG. 5 is an example of a display screen showing a user's personal browsing history generated according to the steps of FIG. 4.

### DETAILED DESCRIPTION OF THE PREFERRED EMBODIMENTS

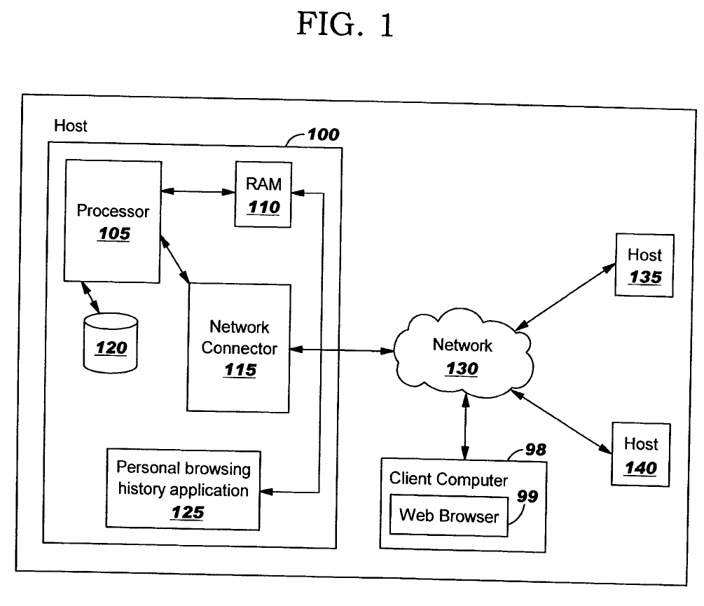

FIG. 1 is a block diagram of a computer system in which the present invention may be incorporated. A client/server data processing host computer 100 is connected to other client/server data processing host computers 135 and 140 via a network 130 such as the Internet. Client/server data processing host 100 includes a processor 105 for executing programs that control the operation of the client/server data processing host 100, a RAM volatile memory 110, a non-volatile memory 120, and a network connector 115 for use in interfacing with the network 130 for communication with the other client/server hosts 135 and 140. FIG. 1 also illustrates a client computer 98 with a web browser 99 for accessing hosts 100, 135 and 140. In an alternate embodiment of the present invention, client computer 98 resides on an intranet (not shown) to enable connection to host 100. Host computer 100 also includes a personal browsing history application program 125 according to the present invention.

Program 125 may be deployed as a standalone client application interfacing with a user's web browser 99 of a user's client computer 98. Program 125 accesses, over network 130, data resources requested from client/server data processing hosts 135 and 140. Alternatively, the personal history application program 125 may be deployed as a server application on client/server data processing hosts 135 or 140 where the client/server data processing host 100 can access the personal history application 125 via the communication network 130. For the remainder of this patent application, the personal browsing history application program 125 will be described as being deployed as a client application on the client/server data processing host 100 and accessing over communication network 130, a plurality of data resources requested from client/server data processing hosts(herein referred to as a web server) 135 and 140.

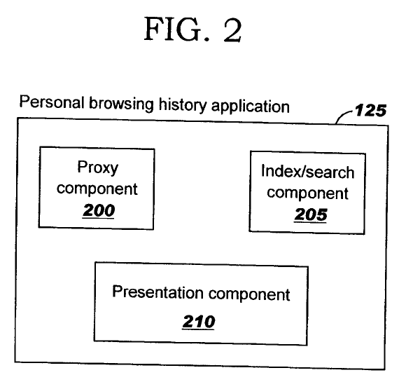

FIG. 2 illustrates the program components of the personal browsing history application program 125—a proxy program component 200, a search/index program component 205 and a presentation program component 210. The proxy component 200 causes the personal browsing history application 125 to keep a local representation of recently accessed data resources. These data resources may be web pages, graphics, downloads or any other resource that are accessed over the network 130. The proxy component 200 also determines, on receipt of a request for a data resource, whether server 100 can handle the request itself or if another proxy server must be contacted to handle or assist in handling the request for the data resource. The latter situation can occur in a corporate environment where requests for data resources outside of the corporate Intranet are configured to be sent to a proxy server before allowing access to the Internet. If the proxy component 200 determines that it can handle the request for a data resource directly, the proxy component 200 accesses the network 130 and contacts the web server 135 or 140 to provide the data resource. The web server 135 or 140 sends the request back to the proxy component 200 residing on the host 100. Once the request is received by the proxy component 200, the request is sent to the user's browser and the index/search component 205 automatically begins to process the data resource. The storing of a representation of an accessed data resource requires no active input from the user, it is carried out automatically by the index/search component 205 when the proxy component 200 inspects each accessed data resource.

The index/search component 205 extracts metadata and textual data from a data resource and indexes the extracted data to form a textual index for searching. In the preferred embodiment of the present invention, this extraction is based on a known mark up language such as HTML. HTML is used to specify the formatting, the presentation and the text and images that comprise the contents of a web page. A typical piece of HTML tagging is as follows:

<html>
<head>
<meta name=“keywords” content=“corporate home page” />
<title>My Company</title>
</head>
<body TEXT=“000000” BGCOLOR=“FFFFFF” leftmargin=0
topmargin=0 marginwidth=0 marginheight=0> The body tag specifies
how to display the text and graphics to a user.
<h1>This is a heading tag </h1>
<p>The start of a new paragraph</p>
</body>
</html>

When the index/search component 205 receives a data resource such as a web page from the proxy component 200, the index/search component traverses each of the html tags and extracts metadata and textual data from the data resource. Examples of the metadata are the URL of the web page, the last modified date, fields specified as metadata in the HTML, the title of the web page, and the amount of text on the web page specified in a word count. The textual data, i.e. the natural language information embedded in the web page between a body tag (<body></body>) is also extracted. Both metadata and textual data are stored with a reference to the original location of the data resource. The reference to the original location of the data resource may comprise an HTTP request or other appropriate protocol.

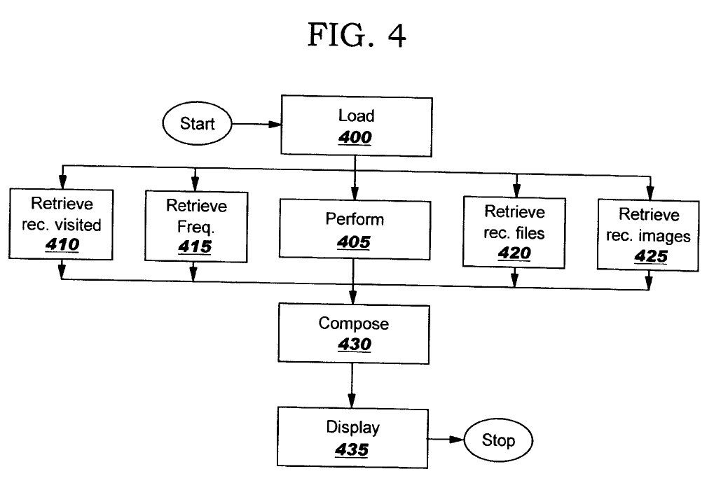

The presentation program component 210 displays a searchable personal browsing history created by the personal history application 125, as described in more detail below with reference to FIG. 4.

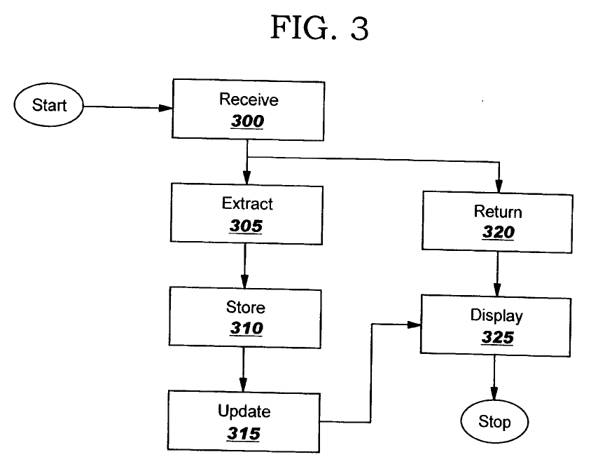

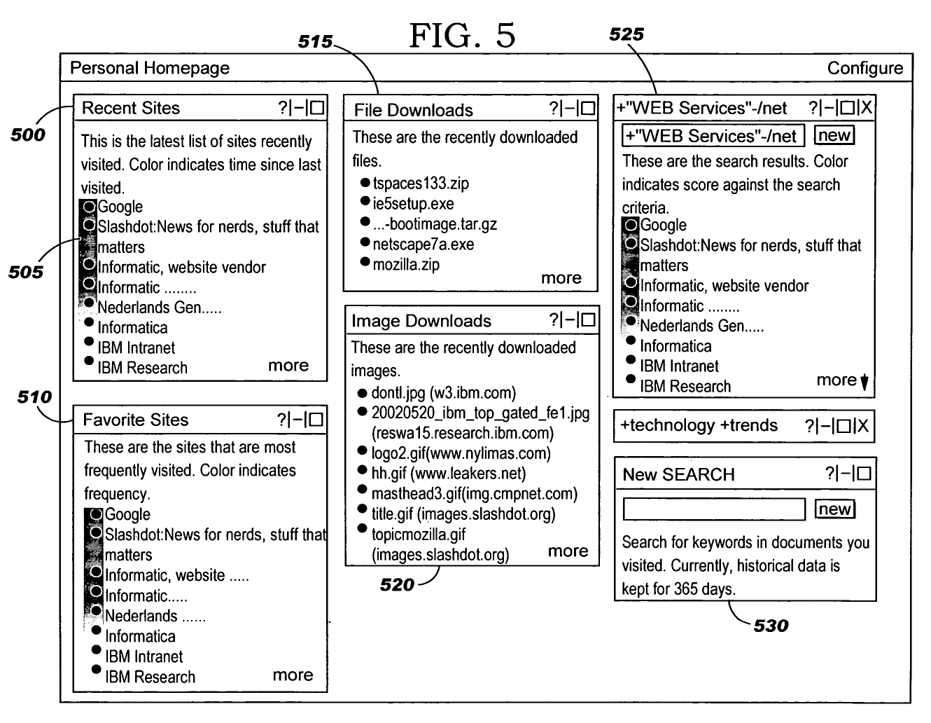

FIG. 3 illustrates how the personal browsing history application 125 operates when accessing a network 130 such as the Internet. At step 300 the user accesses the network (for example, requests a web page) using the personal browsing history application 125 configured to work with the user's browser. A web page or other web resource such as a downloadable file or graphic image may be accessed in the normal manner by entering in a Uniform Resource Locator (URL) into the URL address input box in the user's browser. The browser sends a request message for the web page or other web resource to the proxy component 200, and the proxy component 200 determines whether it can handle the request itself or whether another proxy server must handle the request. If the proxy component 200 can handle the request itself, a request for a data resource is sent through the network 130 to the web server 135 or 140 depending on which web server can provide the requested data resource specified by the URL. In response to the request, the web server 135 or 140 looks up the path name of the requested data resource and sends back the data resource in a reply message through the network 130 to the personal browsing history application 125. At step 320 the proxy component 200 forwards the requested resource to the web browser, where it is loaded into the browser window and displayed to the user at step 325. At step 305 the index/search component 210 extracts metadata and textual data from the contents of the data resource as described previously. As described below, the metadata and the textual data extracted by the index/search component 210 are used to dynamically create a searchable personal browsing history which represents the user's browsing activity when accessing data resources over network 130. The metadata and the textual data extracted in step 305 are stored in a data store at step 310. At step 315 the stored metadata and textual data are indexed (as described below with reference to FIG. 5) to reflect any recently stored metadata and textual data in step 310. A reference to the data resource's original location is also stored at step 310 such that the extracted metadata and the textual data create a textual index along with a reference to the data resource's original web location. Each time the proxy component 200 receives a requested resource, the textual index is updated to reflect the addition of a new data resource. The stored metadata and textual data are indexed each time a data resource is accessed over the network 130 thereby allowing the user to constantly view and search the data resources that they have accessed.

Step 320 is carried out in parallel with steps 305, 310, and 315. In step 320, the requested data resource is supplied to the browser and displayed to the user at step 325. The above steps allow the personal history browsing application 125 to work in the background, constantly extracting, storing and re-indexing the extracted metadata and textual data, while the user is browsing the WWW.

Consider now how the personal browsing history may be used. A user may vaguely remember a web page or other web resource that he or she read some time ago, but not remember where the web page or other web resource is located. As illustrated in FIG. 4, a user can locate a data resource that the user had previously accessed by first loading the presentation component 210 from a menu option within the user's web browser. Then, the user's browser sends a request to the proxy component 200 to initiate the searchable personal browsing history. In response, the proxy component 200 loads the presentation component into the user's browser to display the searchable personal browsing history. At step 400 the proxy component 200 loads the custom user settings for the searchable personal browsing history. The user settings define information about how the user would prefer the searchable personal browsing history to be personalised. The user settings are defined in a user profile and may be modified at any time by the user. The user settings consist of information such as which sections may be displayed in the presentation component 210, access rights of others to the personal history application 125 and password settings. Usability settings may include the color of the text to be displayed in the presentation component within the user's browser when viewing the searchable personal browsing history.

The metadata and textual data that was extracted from the accessed data resource at step 305 of FIG. 3 are retrieved from the data store. The metadata is used to calculate statistical information on the activity of the user accessing over network 130 a plurality of data resources. The type of calculations that may be performed enable the determination of the most recently visited web pages at step 410, the most frequently visited web pages at step 415, the most recently downloaded files by the user at step 420, and the most recently downloaded images by the user at step 425. Thus, the statistical information allows a user to see his or her past browsing activity categorised by the type of calculation performed. At step 405 the user is able to perform a key word search in the index of the stored metadata and textual data. The keyword search is performed by typing search criteria into a search input box. The index/search component 205 uses the search criteria to locate and retrieve the information requested by the user. At step 430 the personal browsing history application 125 creates a searchable personal browsing history which is tailored to the search results, the statistical information and the configuration settings as defined by the user and displayed at step 435. The searchable browsing history may contain the results of multiple searches (iterations of step 405) and their results.

FIG. 5 illustrates a searchable personal browsing history as generated by the personal browsing history application 125 and displayed in step 435 of FIG. 4. The searchable personal browsing history is a dynamic view changing each time the user performs a new search on the index in step 405 of FIG. 4 or accesses over a network 130 one or more data resources. The searchable personal browsing history comprises several different sections, recently visited sites 500, favorite sites 510, downloaded files 515, image downloads 520 and search sections 525 and 530 for inputting search criteria. In the search section 525, the example search criteria shown are ‘+“web services” −.net’. The searchable personal browsing history locates within the indexed data, all references to “web services” and scores the results according to the most relevant. The scoring is displayed to the user by a color gradient bar 505, the higher the score the more intense the color. The scoring is defined by the metadata extracted from the web resource at step 305 of FIG. 3. The search results in each section depend on the information contained within the metadata and in the textual data thereby, displaying information that is only relevant to the user's browsing activity. The user is therefore able to dynamically see which web resources he or she has visited at a particular point in time and quickly locate the information he or she had seen before. The searchable personal browsing history dynamically updates the view every time the user visits another web page or downloads a file or image.

1. A method for displaying a web browsing history, said method comprising the steps of:
displaying a list of names of web sites, said list of web site names being displayed in an order based on an extent to which each named web site matches a key word search initiated by a user; and
displaying next to each of the web site names a respective graphic whose intensity corresponds to the extent to which each named web site matches the key word search initiated by said user.

2. A method as set forth in claim 1 wherein the intensities of said graphics increase as the extent to which the named web sites matches the key word search initiated by said user such that a graphic for a name of a web site with a first extent of match of the key word search is more intense than a graphic for a name of another web site which has a second, lesser extent of match of the key word search.

3. A method as set forth in claim 2 wherein said graphic has a color other than a shade of gray.

4. A method as set forth in claim 1 wherein said graphics adjoin each other to form a generally rectangular region perpendicular to said web site names.

5. A system for displaying a web browsing history, said system comprising:
means for displaying a list of names of web sites, said list of web site names being displayed in an order based on an extent to which each named web site matches a key word search initiated by said user; and
means for displaying next to each of the web site names a respective graphic whose intensity corresponds to the extent to which each named web site matches the key word search initiated by said user.

6. A system as set forth in claim 1 wherein the intensities of said graphics increase as the extent to which the named web sites matches the key word search initiated by said user such that a graphic for a name of a web site with a first extent of match of the key word search is more intense than a graphic for a name of another web site which has a second, lesser extent of match of the key word search.

7. A system as set forth in claim 2 wherein said graphic has a color other than a shade of gray.

8. A system as set forth in claim 1 wherein said graphics adjoin each other to form a generally rectangular region perpendicular to said web site names.

9. A computer program product for displaying a web browsing history, said computer program product comprising:
a computer readable media;
first program instructions to display a list of names of web sites, said list of web site names being displayed in an order based on an extent to which each named web site matches a key word search initiated by said user; and
second program instructions to display next to each of the web site names a respective graphic whose intensity corresponds to the extent to which each named web site matches the key word search initiated by said user; and wherein
said first and second program instructions are stored on said media.

10. A computer program product as set forth in claim 9 wherein the intensities of said graphics increase as the extent to which the named web sites matches the key word search initiated by said user such that a graphic for a name of a web site with a first extent of match of the key word search is more intense than a graphic for a name of another web site which has a second, lesser extent of match of the key word search.

11. A computer program product as set forth in claim 10 wherein said graphic has a color other than a shade of gray.

12. A computer program product as set forth in claim 9 wherein said graphics adjoin each other to form a generally rectangular region perpendicular to said web site names.
